(19) United States
(12) Patent Application Publication
(10) Pub. No.: US 2005/0114647 A1
(43) Pub. Date: May 26, 2005

(54) Using timing signals to determine proximity between two nodes

(76) Inventor: Michael Abraham Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/507,540

(22) PCT Filed: Mar. 11, 2003
(86) PCT No.: PCT/US03/07178

Related U.S. Application Data
(60) Provisional application No. 60/363,589, filed on Mar. 12, 2002.
(60) Provisional application No. 60/445,264, filed on Feb. 5, 2003.

(51) Int. Cl. H04L 9/00

(52) U.S. Cl. 713/153

(57) ABSTRACT

A system and method facilitates a determination of proximity between nodes based on the communication time between the node. A source node communicates a query, or “ping”, to a target node. The target node is configured to automatically send a response to the sender of such a query. The communication time is determined based on the time duration between the transmission of the query and receipt of the response at the source node. The communication time is compared to a threshold value to determine whether the target node is local or remote relative to the source node.

This invention relates to the field of communications security, and in particular, to a system and method that verifies the proximity of a node on a network.

Network security can often be enhanced by distinguishing between ‘local’ nodes and ‘remote’ nodes on the network. In like manner, different rights or restrictions may be imposed on the distribution of material to nodes, based on whether the node is local or remote. Local nodes, for example, are typically located within a particular physical environment, and it can be assumed that users within this physical environment are authorized to access the network and/or authorized to receive files from other local nodes. Remote nodes, on the other hand, are susceptible to unauthorized physical access. Additionally, unauthorized intruders on a network typically access the network remotely, via telephone or other communication channels. Because of the susceptibility of the network to unauthorized access via remote nodes, network security and/or copy protection can be enhanced by imposing stringent security measures and/or access restrictions on remote nodes, while not encumbering local nodes with these same restrictions.

It is an object of this invention to provide a system and method that facilitates a determination of whether a node on a network is local or remote. It is a further object of this invention to integrate this determination with a system or method that enforces security measures and access restrictions based on whether the node is local or remote.

These objects and others are achieved by a system and method that facilitates a determination of communication time between a source node and a target node. The proximity of the target node to the source node is determined from the communication time. The source node communicates a query, or “ping”, to the target node. The target node is configured to automatically send a response to the sender of such a query. The communication time is determined based on the time duration between the transmission of the query and receipt of the response at the source node. The communication time is compared to a threshold value to determine whether the target node is local or remote relative to the source node.

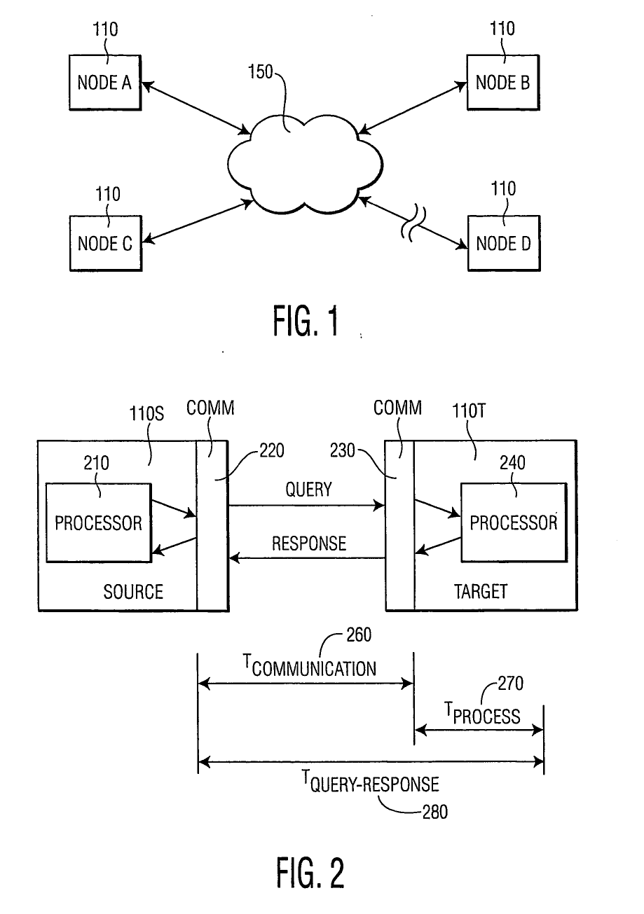

FIG. 1 illustrates an example block diagram of a network of nodes.

FIG. 2 illustrates an example block diagram of a source and target node that effect a query-response protocol in accordance with this invention.

Throughout the drawings, the same reference numeral refers to the same element, or an element that performs substantially the same function.

FIG. 1 illustrates an example block diagram of a network 150 of nodes 110. One of the nodes, NodeD 110, is illustrated as being distant from the other nodes 110. In accordance with this invention, each of the nodes 110 is configured to be able to determine the proximity of each other node 110. In a typical embodiment of this invention, the proximity determination is limited to a determination of whether the other node is “local” or “remote”, although a more precise determination of distance may also be determined, as detailed below.

FIG. 2 illustrates an example block diagram of a source node 110S and target node 110T that effect a query-response protocol to determine the proximity of the target node 110T to the source node 110S in accordance with this invention. The source node 110S includes a processor 210 that initiates a query, and a communications device 220 that transmits the query to the target node 110T. The target node 110T receives the query and returns a corresponding response, via its communications device 230. Conventional techniques, such as the TCP/IP network command “ping” operation, can be used to effect this query and response.

In a preferred embodiment, the query includes an identification of the source node in a form that facilitates a rapid response. For example, the query preferably includes the address of the target node and the address of the source node arranged in such a manner that the target node need only strip its address from the query to form the response. Generally, the response is generated at the processor 240 of the target node 110T, although in a preferred embodiment, the response to the query is generated automatically at the communications device 230 of the target node, to minimize the time required to process the query and generate the response, illustrated in FIG. 2 as the processing time, T_{process} 270.

The source node 110S is configured to measure the time consumed by the query-response process, and from this measure, to determine the proximity of the target node 110T. The query-response time includes the time to communicate the query and response, as well as the aforementioned processing time at the target node 110T. The processing time will vary based on the speed and configuration of the target node 110T. Within a local network, the processing time may exceed the actual communication time, T_{communicate} 260, and thus the measure of the communication time is unreliable. However, if the target node 110T is remote from the source node 110S, the communication time will generally be substantially longer than the expected processing time, and thus the total time, T_{query-response} 280, can be expected to substantially correspond to the communication time. By comparing the query-response time to a nominal threshold value, typically not more than a few milliseconds, the proximity of the target node 110T to the source node 110S can be determined. If the communication time is below the threshold, the target 110T is determined to be local; otherwise, it is determined to be remote. Optionally, multiple threshold levels may be defined to distinguish different ranges of distances, such as whether a remote target node is located within the same country as the source node, and so on.

In a typical embodiment, the source 110S uses the remote/local proximity determination to control subsequent communications with the target 110T. For example, some files may be permitted to be transferred only to local nodes, all communications with a remote node may be required to be encrypted, and so on.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

1. A method of determining proximity of a target node to a source node, comprising:
communicating a query from the source node to the target node,
communicating a response from the target node to the source node,
receiving the response at the source node,
determining a measure of query-response time between communicating the query and receiving the response, and
determining the proximity of the target node based on the measure of query-response time.

2. The method of claim 1, wherein
determining the proximity includes comparing the query-response time to a threshold value that distinguishes between local and remote nodes.

3. The method of claim 2, further including
restricting communications with the target node based on the proximity.

4. The method of claim 1, further including
restricting communications with the target node based on the proximity.

5. The method of claim 1, wherein
communicating the query and response is effected via a TCP/IP ping network command.

6. A node on a network including:
a communication device that is configured to transmit a query to a target node and to receive a corresponding response from the target node,
the response from the target node including a measure of processing time required to generate the response at the target node, and
a processor that is configured to:
generate the query,
receive the response,
measure a query-response time between generating the query and receiving the response, and
determine a proximity of the target node relative to the node based on the query-response time.

7. The node of claim 6, wherein
the processor is configured to determine the proximity based on a comparison of the query-response time to a threshold value that distinguishes between local and remote nodes.

8. The node of claim 7, wherein
the processor is further configured to control subsequent communications with the target node based on the proximity.

9. The node of claim 6, wherein
the processor is further configured to control subsequent communications with the target node based on the proximity.

10. The node of claim 6, wherein
the processor generates the query using a TCP/IP ping network command.
